(19) United States
(12) Patent Application Publication
(10) Pub. No.: US 2004/0125078 A1
(43) Pub. Date: Jul. 1, 2004

(54) Input device

(76) Inventors: Takashi Nishimori, Izumi-shi (JP); Gantetsu Matsui, Nishinomiya-shi (JP)

Correspondence Address: SNELL & WILMER L.L.P., Suite 1200, 1920 Main Street, Irvine, CA, 92614-7230, US

(21) Appl. No.: 10/670,694

(22) Filed: Sep. 25, 2003

(30) Foreign Application Priority Data
Oct. 2, 2002 (JP) 2002-290083
May 15, 2003 (JP) 2003-137759

(51) Int. Cl. G09G 5/00

(52) U.S. Cl. 345/156

(57) ABSTRACT

An input device has buttons on each of which an image appears. The input device detects pressing of a button, and changes images appearing on buttons according to functions allocated to the buttons.

### BACKGROUND OF THE INVENTION

(1) Field of the Invention

The present invention relates to an input device that enables input via its buttons.

(2) Related Art

Information terminals including mobile terminals and personal computers, game machines, and remote controllers for home appliances etc., have been conventionally operated via input devices, such as keyboards and ten-key numeric pads on which buttons or keys (hereafter, “buttons”) are arranged.

Such an input device as a keyboard is operated by a user pressing a button provided thereon. Upon sensing the depressing move of the button, the input device executes a function allocated to the button. The user can have a tactile response when pressing a button of this input device. Also, with each button being separate from the surface of a main body of this input device, the user can easily find the position of each button.

In this way, input devices with buttons are advantageous inputting means having a low probability of causing input errors.

For input devices with buttons, various techniques have been developed to efficiently realize a greater number of functions using a limited number of buttons. For example, Japanese Laid-Open Patent Application No. 2001-309014 discloses a technique for allocating a plurality of functions to one button and for allocating a function of frequent use to a freely-chosen button according to preference of each user.

However, this conventional technique has the following problems. A plurality of characters and the like indicating a plurality of functions need to be written in a limited space of the surface of one button, for the purpose of letting the user know the functions allocated to the button. Such characters on one button are inevitably so small that the user has difficulties in reading them to know the functions of the button. For example, five characters “2”, “a”, “b”, “c”, and “ [symbol] (Hiragana character)” may have to be printed on one key of a mobile telephone.

Moreover, with a plurality of functions being allocated to one button, the user cannot find which function is presently valid simply by looking at the button. Further, when the user allocates a freely-chosen function to a freely-chosen button, characters printed on the surface of the button may not necessarily indicate the allocated function. In this case, the user cannot find the allocated function simply by looking at the button.

On the other hand, the present trend toward smaller mobile terminals etc. causes their buttons to be smaller and gaps between adjacent buttons to be narrower accordingly. With this trend, the demand is growing for input devices whose button positions can be easily checked by the user's fingers and whose buttons provide the user with good tactile response.

### SUMMARY OF THE INVENTION

In view of the above problems, the object of the present invention is to provide an input device that enables the user to easily find a plurality of functions allocated to one button without writing all characters indicating the functions in a limited space of the surface of the button.

The above object of the present invention can be achieved by an input device including: one or more buttons on each of which an image is appearing; a button-pressing detecting unit operable to detect a button-pressing operation; and a button-image changing unit operable to change an image appearing on at least one of the buttons when the button-pressing detecting unit detects the button-pressing operation. Here, the button-image changing unit may change an image appearing on a button that has been pressed via the button-pressing operation detected by the button-pressing detecting unit. Also, the button-image changing unit may change an image appearing on a button other than a button that has been pressed via the button-pressing operation detected by the button-pressing detecting unit.

The button on which an image is appearing referred to herein is specifically a button whose image appearing thereon can be switched between a plurality of images. Such a button is formed by a member that can be moved up and down by a user operation.

According to this construction, every time when a button is pressed to change its function, images appearing on buttons are changed. Therefore, the user can easily find a presently valid function of each button.

Here, the input device may further include one or more display panels that are placed behind the one or more buttons, wherein each button is at least partially made from one of a transparent material and a semi-transparent material, and the button-image changing unit may change an image displayed on the one or more display panels, to change the image appearing on the at least one of the buttons.

According to this construction, an image appearing on a button can be changed by changing an image displayed on a display panel placed behind the button. Therefore, an image displayed on each button can be switched between various images.

Also, the input device may further include one or more display panels that are placed behind the one or more buttons, wherein each button is at least partially made from one of a transparent material and a semi-transparent material, and the button-image changing unit may change an image displayed on the one or more display panels, to change the image appearing on the at least one of the buttons.

According to this construction, images appearing on a plurality of buttons can be changed simply by generating one piece of bitmap data. Therefore, generation, management, etc. of data can be simplified. Further, with the only one piece of bitmap data being subjected to display processing, the entire processing time can be shortened.

Also, the input device may further include a transparent touch panel that is placed on the one or more display panels so as to be positioned between the one or more display panels and the one or more buttons; and an elastic member that is placed between the transparent touch panel and the one or more buttons to space the touch panel and the one or more buttons, wherein the pressing-operation detecting unit detects the button-pressing operation by the touch panel detecting a pressure generated by deformation of the elastic member.

According to this, the construction of the input device can be simplified. The input device with such a simplified construction includes a reduced number of components and requires a reduced number of manufacturing steps.

Also, the one or more display panels may be placed, in one-to-one correspondence, behind the one or more buttons, and the corresponding display panel and button may be bonded together.

According to this construction, a display panel is provided for each button. Therefore, not only an image to appear on each button but also illuminance and the like of an image to appear on each button can be changed depending on each button.

Also, the button-image changing unit may include: a correspondence storing unit operable to store therein information about correspondence of each button, a processing program, and an image; and a button-processing analyzing unit operable to (a) execute a processing program corresponding to a button that has been pressed via the button-pressing operation, (b) redefine the correspondence of each button, a processing program, and an image, and (c) display, in accordance with the redefined correspondence, images on the one or more display panels in such a manner that an image corresponding to each button appears on the corresponding button.

According to this construction, a function to be allocated to each button and an image to appear on each button can be defined. Therefore, a freely-chosen function can be allocated to a freely-chosen button. Further, an image indicating a function allocated to each button can be set to appear on the corresponding button.

Also, the input device may further include: a change-information obtaining unit operable to obtain information to be used for changing the correspondence; and a correspondence changing unit operable to change the correspondence using the information obtained by the change-information obtaining unit.

According to this construction, the user can allocate a function to a freely-chosen button, and also can change an image to appear on each button. Therefore, each user can freely adjust the operations in a manner that is friendly to the individual user. For example, the user can allocate a function that he or she frequently uses to a button at an easily accessible position, and can set to display an image with a bright color on the button of frequent use. Further, the confidentiality can be maintained for example by setting to display, on the button of frequent use, such an image that does not allow a third party to find the allocated function.

Also, the image appearing on each button may include an image of a character.

According to this construction, freely-chosen characters can be set to appear on each button. Therefore, the number of times a button is operated for inputting characters can be reduced, thereby improving the operability of the input device. For example, such an image as an emoticon that is made up of a combination of a plurality of characters and special characters like a colon and that provides a certain meaning may be set to appear on a button, and such an image as an emoticon may be input by pressing that button. In this way, the number of times buttons are operated for input can be reduced.

### BRIEF DESCRIPTION OF THE DRAWINGS

These and other objects, advantages and features of the invention will become apparent from the following description thereof taken in conjunction with the accompanying drawings that illustrate a specific embodiment of the invention.

In the drawings:

FIG. 1A is a schematic perspective view of an input device 1000 relating to a first embodiment of the present invention for use in a mobile terminal;

FIG. 1B is a schematic diagram showing the structure of a button unit of the input device 1000;

FIG. 1C is a side cross sectional view of the button unit;

FIG. 2 is a functional block diagram of the input device 1000;

FIG. 3A shows an example of a piece of correspondence data in an initial state of the character mode (hereafter, “ABC mode”) stored in a correspondence-data storing unit 1400;

FIG. 3B shows an example of a piece of correspondence data after the “:-)” button is pressed in the initial state of the ABC mode and the emoticon processing is executed;

FIG. 4 shows an example of the structure and contents of button display data to be used to display images on buttons;

FIG. 5 is a flowchart showing a button-processing analyzing process executed by a button-processing analyzing unit 1300;

FIG. 6 shows display examples of the input device 1000 for use in a mobile terminal, in the case of inputting an emoticon, the button display states “60-a” to “60-d” representing display examples changed according to button operations;

FIG. 7 shows display examples of the input device 1000 for use in a mobile terminal, in the case of inputting a punctuation symbol “!”, the button display states “70-a” to “70-d” representing display examples changed according to button operations;

FIG. 8A shows a schematic perspective view of an input device 3000 relating to a second embodiment of the present invention for use in a mobile terminal;

FIG. 8B is a side cross sectional view of buttons of the input device 3000; and

FIG. 9 is an exploded perspective view of the input device 3000 to show the relationship between a display panel and buttons included therein.

### DESCRIPTION OF THE PREFERRED EMBODIMENTS

<First Embodiment>

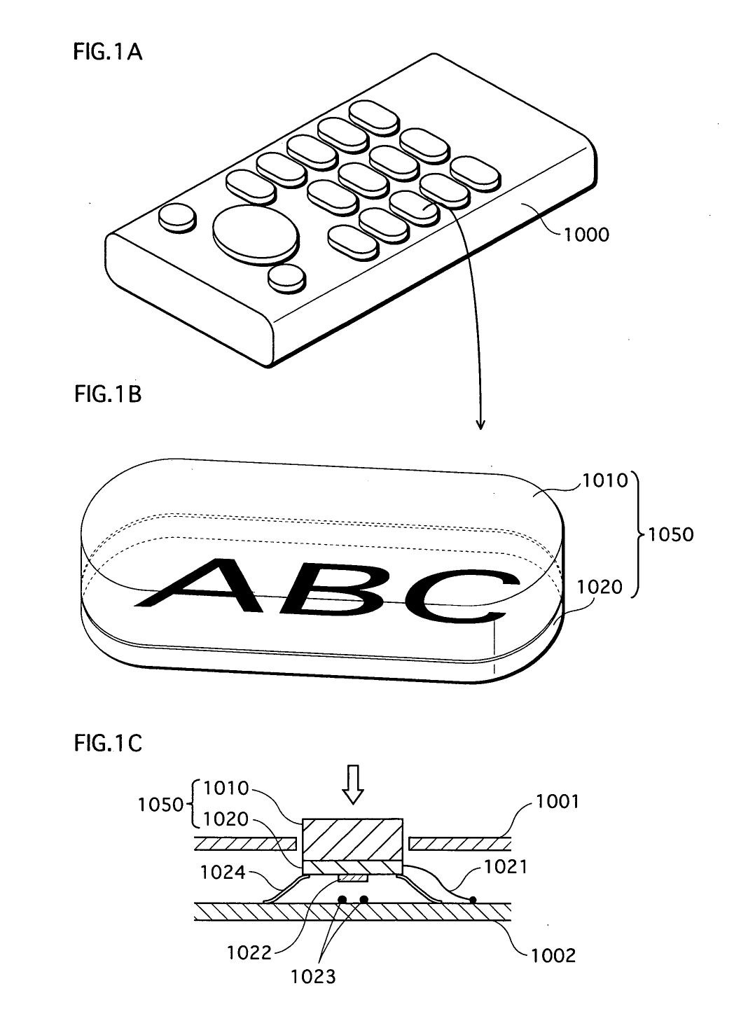

The following describes an input device 1000 relating to a first embodiment of the present invention, with reference to FIGS. 1 to 7.

<Construction>

FIGS. 1A, 1B, and 1C are schematic diagrams of the input device 1000 relating to the first embodiment for use in a mobile terminal. FIG. 1A is a perspective view of the input device 1000. FIG. 1B is a diagram showing the structure of a button unit of the input device 1000. FIG. 1C is a cross sectional view of the button unit.

The input device 1000 has a plurality of button units 1050 arranged thereon.

The button units. 1050 are-each composed of a button 1010 and a display panel 1020. The button 1010 and the display panel 1020 are bonded together. The button 1010 is made from a transparent material. An image displayed on the display panel 1020 positioned behind the button 1010 can be viewed by the user through the transparent button 1010, as an image appearing on the surface of the button 1010. Hereafter in this specification, such an image appearing on the surface of a button may be simply referred to as an “image appearing on a button” or an “image displayed on a button”. The button unit 1050 is provided as being separate from a surface member 1001 of the input device 1000, and partially protrudes from the surface member 1001 of the input device 1000.

The physical operations of the button unit 1050 are the same as those in the case of a conventional input device with buttons. The button unit 1050 is supported by an elastic member 1024 placed behind the button unit 1050. When the user presses the button unit 1050 against the elastic force of the elastic member 1024, a switch corresponding to the pressed button unit 1050 is turned on.

To be more specific, a circuit substrate 1002 is placed behind the button unit 1050, a conductive unit 1022 is provided on a back surf ace of the button unit 1050, and a contact pattern 1023 is formed on the circuit substrate 1002 so as to face the conductive unit 1022. Further, a CPU and a memory are mounted on the circuit substrate 1002. To transmit control signals and display data between the CPU and the display panel 1020, a flexible cable that is a conductor 1021 extends from the circuit substrate to the display panel 1020.

When the button unit 1050 is pressed by the user, the elastic member 1024 elastically supporting the button unit 1050 from behind receives pressure from the button unit 1050 and is deformed by the pressure. The conductive unit 1022 on the back surface of the button unit 1050 then comes in contact with the facing contact pattern 1023, to achieve conduction between them. When the pressure is removed, the deformed elastic member 1024 returns to its original shape by its own elastic force. The button unit 1050 receives pressure from the elastic member 1024, and returns to its original position shown in the figure.

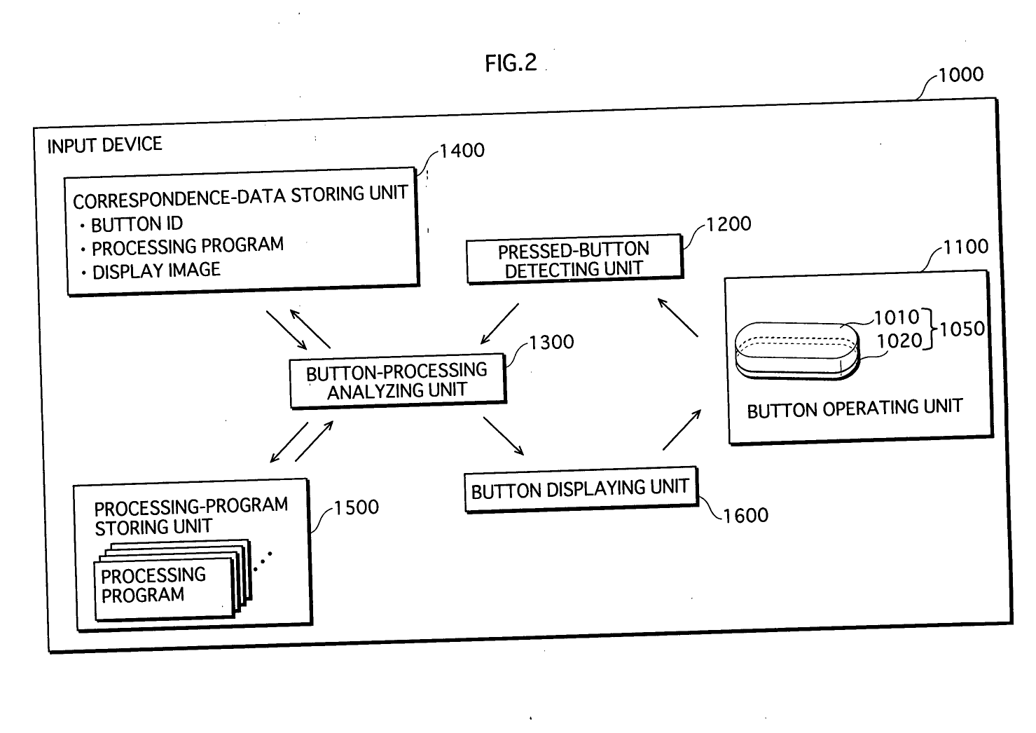

FIG. 2 is a functional block diagram of the input device 1000 relating to the first embodiment.

The input device 1000 is roughly composed of a button operating unit 1100, a pressed-button detecting unit 1200, a button-processing analyzing unit 1300, a correspondence-data storing unit 1400, a processing-program storing unit 1500, and a button displaying unit 1600.

The button operating unit 1100 includes one or more button units 1050 and a circuit of the circuit substrate 1002 for processing a signal that is input by pressing each button unit 1050. The button operating unit 1100 receives such an input operation from the user.

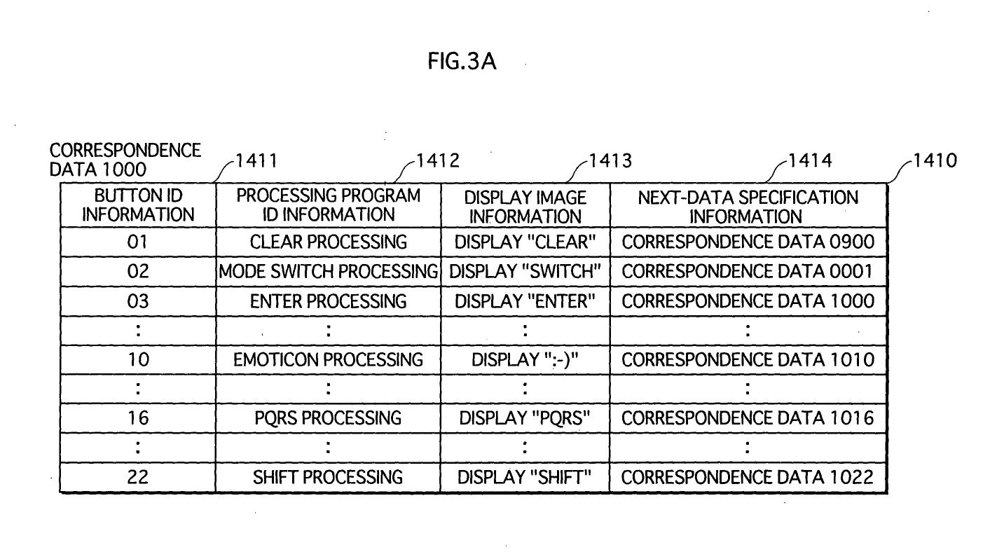

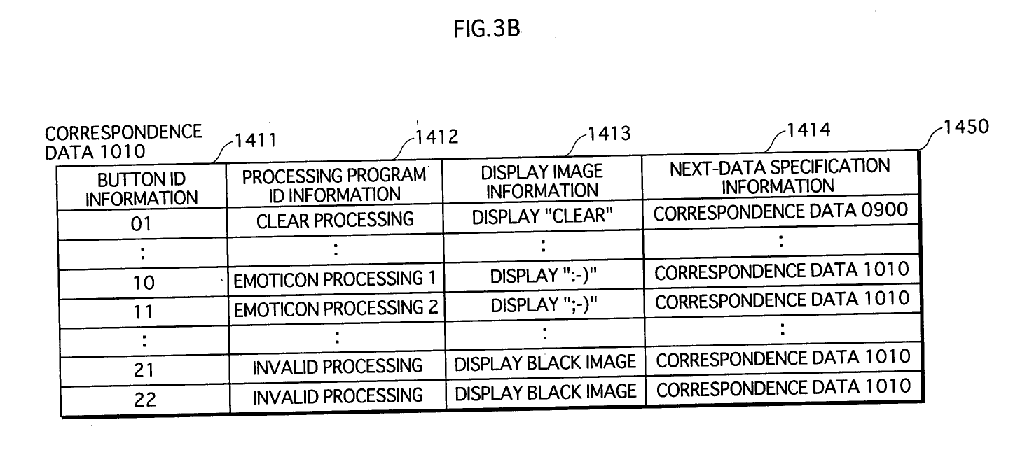

The pressed-button detecting unit 1200 detects pressing of a button unit 1050, and sends an identification number of the pressed button unit 1050 to the button-processing analyzing unit 1300. To be more specific, the pressed-button detecting unit 1200 converts a signal that is input by pressing a button unit 1050 on the circuit substrate 1002, into an identification number of the button unit 1050. An identification number (button ID information) of the button unit 1050 is described later, with reference to FIG. 3.

The button-processing analyzing unit 1300 realizes a function allocated to the pressed button 1010. To be more specific, the button-processing analyzing unit 1300 refers to the correspondence-data storing unit 1400, to obtain ID information of a processing program corresponding to the pressed button unit 1050 and information about an image to be displayed on each button (hereafter, “display image information”). The button-processing analyzing unit 1300 then executes a processing program identified by the obtained ID information, and requests the button displaying unit 1600 to change a display image of each button using the obtained display image information. Processing programs are stored in the processing program storing unit 1500, for execution by a CPU within the input device 1000.

The correspondence-data-storing unit 1400 is such a storage area as a memory for storing data showing correspondence of button ID information, processing program ID information, and display image information. The data showing such correspondence (hereafter, “correspondence data”) is described in detail later, with reference to FIG. 3.

The processing program storing unit l500 is such a storage area as a memory for storing processing programs used to realize functions allocated to each button unit 1050.

The button displaying unit 1600 changes display images of button units 1050 when requested to do so by the button-processing analyzing unit 1300. To be more specific, the button displaying unit 1600 converts character codes and the like sent from the button-processing analyzing unit 1300 into pieces of bitmap data, and sends the pieces of bitmap data to the button operating unit 1100.

The button operating unit 1100 receives pieces of bitmap data from the button displaying unit 1600, and displays each piece of bitmap data on a display panel 1020 behind the corresponding button 1010. Pieces of bitmap data into which character codes are to be converted, color data, etc. are stored in a memory within the input device 1000.

<Data>

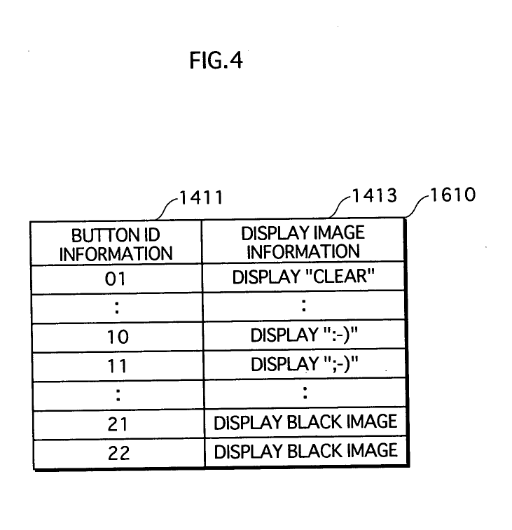

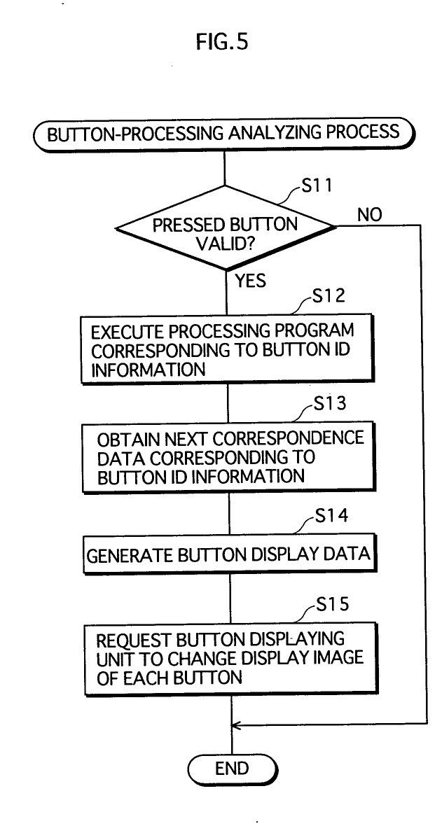

The following describes main data handled by the input device 1000, with reference to FIGS. 3A, 3B, and 4.

FIGS. 3A and 3B each show an example of a piece of correspondence data stored in the correspondence-data storing unit 1400, exemplifying its data structure and contents. FIGS. 3A and 3B show pieces of correspondence data with different contents. The contents of each piece of correspondence data are described below.

A plurality of pieces of correspondence data are stored in the correspondence-data storing unit 1400. One of the pieces of correspondence data is the present set of correspondence data showing the present state, i.e., a processing program for realizing a function presently allocated to each button and present display image information of each button. When the user presses a button to change the present state to another state, another piece of correspondence data is newly set as the present piece of correspondence data.

Here, apiece of correspondence data 1410 is specifically a table that is made up of a “button ID information” field 1411, a “processing program ID information” field 1412, a “display image information” field 1413, and a “next-data specification information” field 1414.

Here; the button ID information 1411 is used to identify a button unit 1050 that has been pressed. The button ID information 1411 is specifically a unique identifier given to each physical button.

The processing program ID information 1412 is used to identify a processing program corresponding to the pressed button unit 1050.

The display image information 1413 is information about an image to be displayed on the button unit 1050. In a case where an image of characters is displayed on the button unit 1050, the display image information 1413 is specifically composed of character codes, size, and color, etc. of the characters. In a case where an image of a drawing etc. is displayed on the button unit 1050, the display image information 1413 is specifically composed of a file name of a piece of bitmap data etc.

The next-data specification information 1414 is information used to specify a next piece of correspondence data, which is to be newly set as the present piece of correspondence data after a button unit 1050 identified by the button ID information 1411 is pressed and a processing program corresponding to the pressed button unit 1050 is executed.

FIG. 3A shows a piece of correspondence data 1410 specified by the data specification information “correspondence data 1000”.

In FIG. 3A, the following now focuses on the row of the table in which the button ID information 1411 is “10”. This row indicates that the emoticon “:-)” appears on a button identified by the button ID information “10”, and a processing program identified by the ID information “emoticon processing” is executed when the user presses the button on which the emoticon “:-) ” is displayed. Also, a piece of correspondence data identified by the next-data specification information “correspondence data 1010” is newly set as the present piece of correspondence data after the button identified by the button ID information “10” is pressed and the processing program identified by the ID information “emoticon processing” is executed.

FIG. 3B shows a piece of correspondence data 1450 specified by the data specification information “correspondence data 1010”.

In FIG. 3B, the following now focuses on the row of the table in which the button ID information 1411 is “21”. On this row, the display image information “display black image” indicates that a solid black image is to be displayed on a button identified by the button ID information “21”. Also, the processing program ID information “invalid processing” indicates that the button identified by the button ID information “21” is invalid, and therefore no processing is executed when the user presses the button on which a solid black image is displayed.

FIG. 4 shows an example of button display data to be used to display images on buttons, exemplifying its data structure and contents.

The button display data 1610 is sent from the button-processing analyzing unit 1300 to the button displaying unit 1600 together with a request to change a display image of each button.

Here, the button display data 1610 is specifically a table composed of a “button ID information” field 1411 and a “display image information” field 1413.

The button ID information 1411 and the display image information 1413 are the same as those included in the piece of correspondence data 1410.

<Operations>

The following describes the operations of the input device 1000 having the above-described construction, with reference to FIGS. 5 to 7.

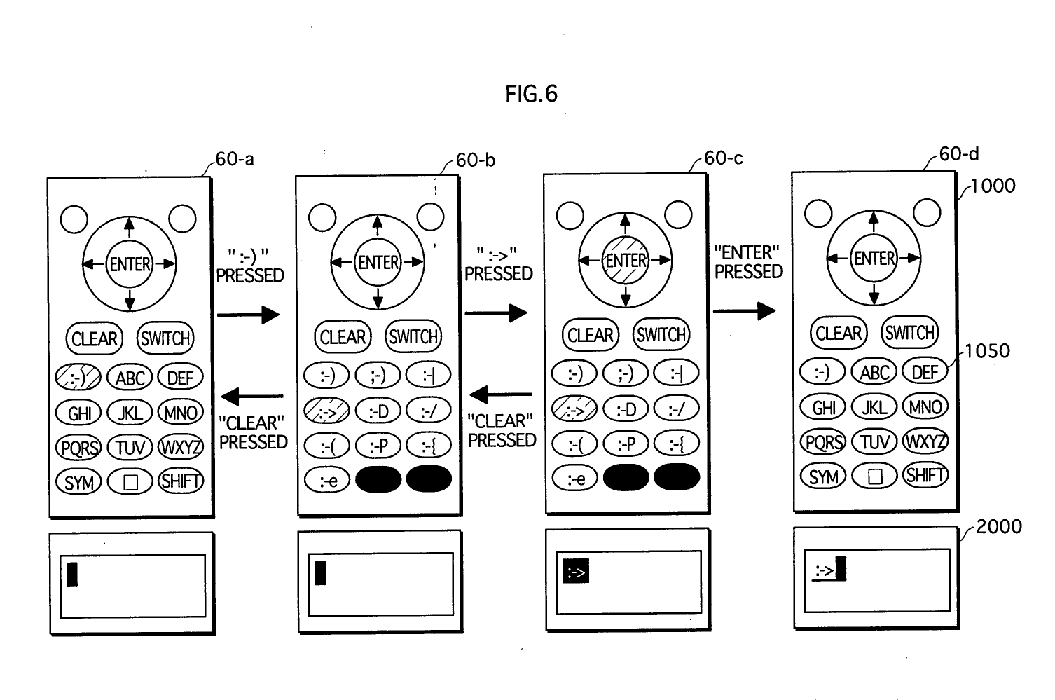

FIG. 6 shows display examples of the input device 1000 in the case of inputting an emoticon. The button display states “60-a” to “60-d” represent display examples changed according to the user's operations of pressing buttons.

The input device 1000 has, on its main surface, a plurality of button units 1050 and a display screen 2000 for displaying input characters such as A, B, and C.

Among the buttons of the input device 1000, the SWITCH button has a function of switching an input mode between an ABC mode for inputting alphabetical characters, a numeric mode for inputting numbers, an emoticon mode for inputting emoticons etc., by the user's operation of pressing the SWITCH button. The CLEAR button has a function of returning to the previous state. The ENTER button has a function of entering an input.

The following specifically describes the button display states of the input device 1000 taking for example the case where the emoticon “:->” is to be input.

The description starts from an initial state of the ABC mode, i.e., the state immediately after the SWITCH button is pressed to switch the input mode to the ABC mode. Images displayed on the buttons in the initial state of the ABC mode are those in the button display state “60-a” shown in FIG. 6.

The display images of the button units 1050 in the button display state “60-a” are based on a piece of correspondence data defined in advance for the initial state of the ABC mode. The piece of correspondence data shown in FIG. 3A is this piece of correspondence data defined for the initial state of the ABC mode.

To be specific, the display images of the button units 1050 in the button display state “60-a” are images of alphabetical characters, i.e, images of “ABC” to “WXYZ”, an image of the emoticon “:-)”, an image of “SYM” representing special characters such as punctuation symbols, an image of “□” representing a space, and an image of “SHIFT” representing a shift between capital and lower-case characters.

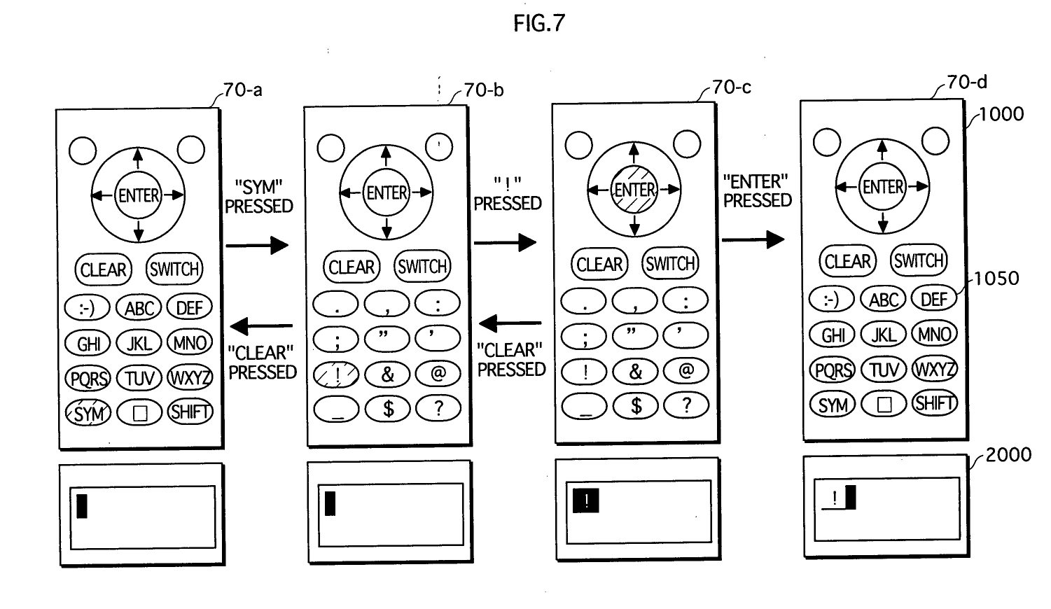

An input target here is the emoticon “:->”. To switch the input mode to the emoticon mode, therefore, the “:-)” button is first pressed. It should be noted here that in FIGS. 6 and 7 a button to be pressed in each button display state is hatched for ease of explanation.

When the “:-)” button is pressed, the button operating unit 1100 senses pressing of the button, and sends information about the sensing to the pressed-button detecting unit 1200. The pressed-button detecting unit 1200 sends the button ID information “10” of the pressed button to the button-processing analyzing unit 1300. The button-processing analyzing unit 1300 receives the button ID information “10” of the pressed button, and executes a button-processing analyzing process. The button-processing analyzing unit 1300 then sends the button display data 1610 to the button displaying unit 1600 together with a request to change a display image of each button. The button-processing analyzing process executed by the button-processing analyzing unit 1300 is described in detail later, with reference to FIG. 5.

The button displaying unit 1600 receives the button display data 1610 including button display information such as character codes for each button. The button displaying unit 1600 converts the button display information into pieces of bitmap data corresponding to the buttons. The button displaying unit 1600 then sends the pieces of bitmap data to the button operating unit 1100, together with a request to display each piece of bitmap data on the corresponding button.

The button operating unit 1100 receives the pieces of bitmap data to be displayed on the button units 1050, and displays each piece of bitmap data on a display panel 1020 placed behind the corresponding button.

It should be noted here that the same number of pieces of bitmap data are generated as the number of buttons whose display images are to be changed, and that the display processing is executed the same number of times as the number of buttons whose display images are to be changed.

The state where the display processing is completed is the button display state “60-b”, i.e., the state where the input mode has been switched to the emoticon mode.

FIG. 5 is a flowchart showing the button-processing analyzing process executed by the button-processing analyzing unit 1300.

First, the button-processing analyzing unit 1300 judges whether a button identified by the button ID information 1411 sent from the pressed-button detecting unit 1200 is valid. In other words, the button-processing analyzing unit 1300 judges whether the button has a function allocated thereto (step S11). When judging that the button is invalid, the button-processing analyzing unit 1300 ends the process. When judging that the button is valid, the button-processing analyzing unit 1300 executes a processing program identified by the processing program ID information 1412 corresponding to the button ID information (step S12). Following this, the button-processing analyzing unit 1300 obtains a next piece of correspondence data using the next-data specification information 1414 corresponding to the button ID information (step S13).

The button-processing analyzing unit 1300 that has obtained the next piece of correspondence data generates button display data 1610 using the button ID information 1411 and the display image information 1413 (step S14). The button-processing analyzing unit l300 then sends the generated button display data 1610 to the button displaying unit 1600, together with a request to change a display image of each button (step S15).

The following describes a specific example of the button-processing analyzing process using the piece of correspondence data shown in FIG. 3A.

Assume here that the user presses the “:-)” button. The button-processing analyzing unit 1300 first receives the button ID information “10” corresponding to the pressed button. The button-processing analyzing unit 1300 judges that this button is valid because the processing program ID information 1412 corresponding to the button ID information “10” is other than “invalid processing” (step S11). Judging that the button is valid, the button-processing analyzing unit 1300 executes a processing program identified by the ID information “emoticon processing” corresponding to the button ID information “10” (step S12). The button-processing analyzing unit 1300 obtains the next-data specification information “correspondence data 1010” corresponding to the button ID information “10” (step S13). Here, the piece of correspondence data 1450 shown in FIG. 3B is specified as a next piece of correspondence data using the next-data specification information “correspondence data 1010”.

The button-processing analyzing unit 1300 generates the button display data 1610 shown in FIG. 4 using the button ID information and the display image information included in the piece of correspondence data 1450 (step S14). The button-processing analyzing unit 1300 sends the generated button display data to the button displaying unit 1600, together with a request to change a display image of each button unit 1050 (step S15).

Following this, the “:->” button in the button display state “60-b” in FIG. 6 is pressed, so that the emoticon “:->” is displayed, as an input, on the display screen 2000 (the button display state “60-c” in FIG. 6). The ENTER button is then pressed, so that the input of the emoticon “:->” is entered (the button display state “60-d” in FIG. 6).

FIG. 7 shows display examples of the input device 1000 in the case of inputting a punctuation symbol. An input target here is the symbol “!”. The button display states “70-a” to “70-d” represent display examples changed according to the user's operations of pressing buttons.

The operations of the input device 1000 in the case of FIG. 7 are basically the same as its operations in the case of FIG. 6, except the following point. In the case of FIG. 7, display images of buttons including the “SYM” button pressed in the button display state “70-a”are changed, whereas in the case of FIG. 6 only display images of buttons other than the “:-)” button pressed in the button display state “60-a” are changed.

<Second Embodiment>

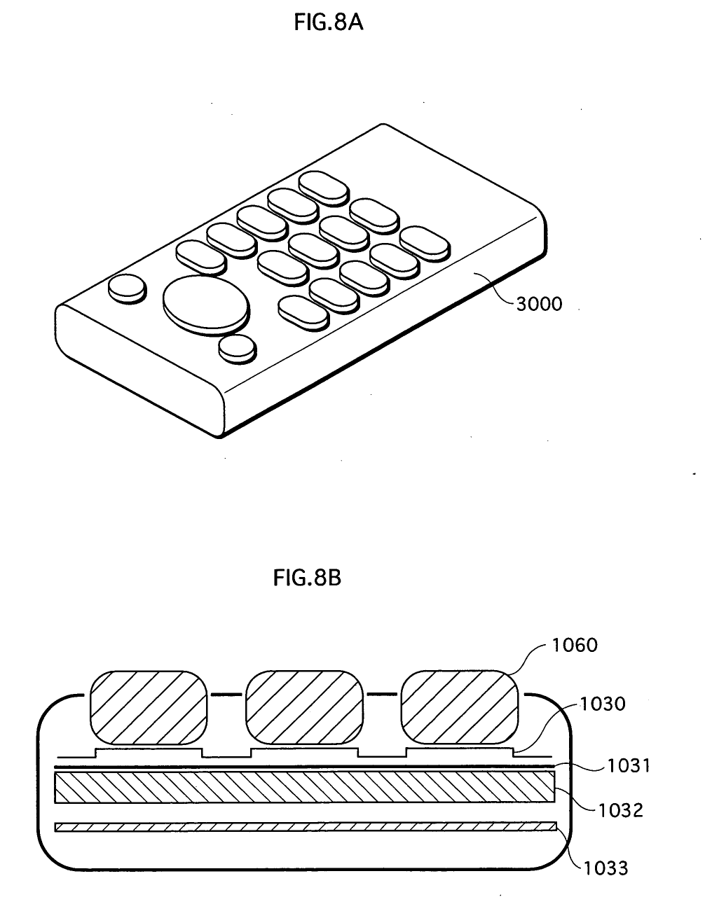

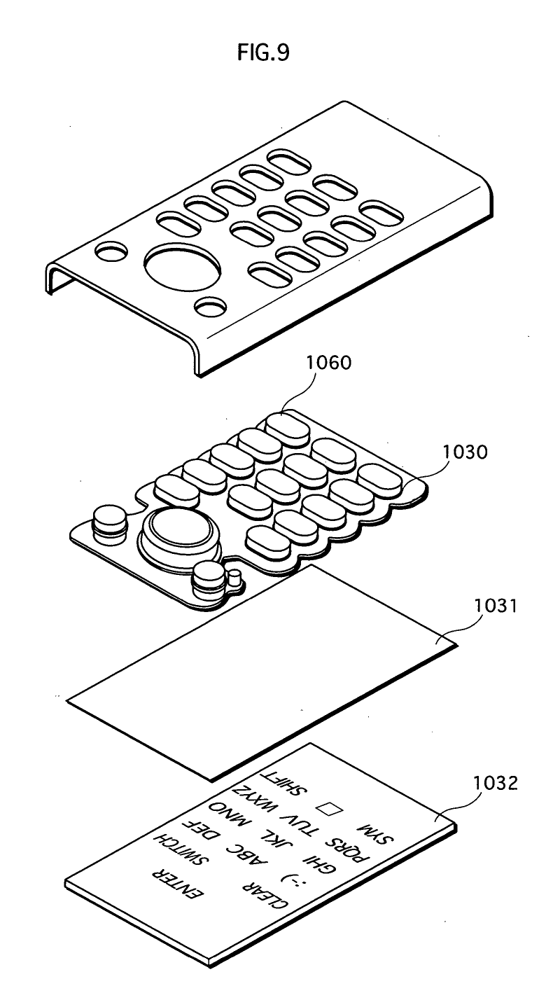

The following describes an input device 3000 relating to a second embodiment of the present invention, with reference to FIGS. 8 and 9.

<General Outline>

The input operations of the input device 3000 for use in a mobile terminal are the same as those of the input device 1000 relating to the first embodiment. To be specific, when a button 1060 of the input device 3000 is pressed, a switch corresponding to the pressed button 1060 is turned on.

The second embodiment differs from the first embodiment in that only one display panel 1032 is provided for a plurality of buttons 1060 in the second embodiment whereas a plurality of display panels 1020 are provided in one-to-one correspondence to a plurality of buttons 1010 in the first embodiment. Therefore, one display panel 1032 is used to change display images of a plurality of buttons 1060 in the second embodiment, whereas a plurality of display panels 1020 are used to change display images of a plurality of buttons 1010 in the first embodiment.

<Construction>

FIGS. 8A and 8B are schematic diagrams of the input device 3000 relating to the second embodiment for use in a mobile terminal. FIG. 8A is a perspective view of the input device 3000. FIG. 8B is a cross sectional view of buttons 1060 of the input device 3000.

The buttons 1060 are made from a transparent material. Behind the buttons 1060, an elastic member 1030, a touch panel 1031, a display panel 1032, and a circuit substrate 1033 are provided. The touch panel 1031 and the elastic member 1030 are both made from a transparent material, so that the user can view images displayed on the display panel 1032 through the transparent buttons 1060, as images appearing on the surfaces of the buttons 1060. The buttons 1060 are bonded to the elastic member 1030. The elastic member 1030 may be partially transparent, as long as it allows the user to view images displayed on the display panel 1032 through the buttons 1060.

FIG. 9 is an exploded perspective view of the input device 3000 to show the relationship between the display panel 1032 and the buttons 1060 included therein.

An image of characters etc., is displayed in an area on the display panel 1032 positionally corresponding to each button 1060, so that each display image appears on its corresponding button 1060. To be more specific, an image of characters “ABC” etc., of appropriate size is displayed at an appropriate position on the display panel 1032, so that the image of the characters appears on the corresponding button 1060, through the touch panel 1031, the corresponding button 1060, and the elastic member 1030.

The buttons 1060 are normally spaced from the touch panel 1031 due to the elastic member 1030 placed between them. When a button 1060 is pressed by the user, the elastic member 1030 is deformed, so that the pressed button 1060 comes in contact with the touch panel 1031. The touch panel 1031 senses the pressure, and sends information about the position of the pressure to the circuit substrate 1033. The pressed button 1060 is detected using the information about the position.

The operations of the input device 3000 subsequent to the detecting of the pressed button are substantially the same as those described in the first embodiment. With only one display panel 1032 being provided for the buttons 1060, however, the operations of the input device 3000 slightly differ from the operations of the input device 1000 having the plurality of display panels 1020 for the buttons 1010 shown in FIG. 1. The following describes such a difference.

In the first embodiment, the same number of pieces of bitmap data as the number of buttons 1010 whose display images are to be changed are generated and the display processing is executed the same number of times as the number of buttons 1010 whose display images are to be changed. In the second embodiment, however, only one piece of bitmap data is generated and the display processing is executed only once, regardless of the number of buttons 1060 whose display images are to be changed.

<Modifications>

Although the input device of the present invention is described based upon the above embodiments, it should be clear that the present invention is not limited to the above embodiments. The input device can be partially modified as follows.

(1) Although the above embodiments describe the case where each piece of correspondence data is defined in advance, to show correspondence of button ID information, a processing program, and display image information, the user may freely define such correspondence data. In this case, means of defining correspondence data and of inputting the defined corresponding data needs to be provided. Each piece of correspondence data may also be defined via a communication line, or by way of downloading data from a storage medium. Also, data of operational history of each user may be recorded, and correspondence data may be redefined based on the recorded history data. By doing so, the input device can realize user-friendliness in accordance with preference of each user.

(2) Although the above embodiments describe the case where the input device of the present invention is for use in a mobile terminal, the present invention may also be such an input device as a remote controller for an apparatus and an accessory input device of a home appliance, or may be a part of an apparatus. Also, the input device of the present invention may be used as an input device for multiple apparatuses. For example, the same input device of the present invention may be used both as an input device for a mobile terminal and as a remote controller for a television set etc. In conventional cases, the same number of input devices as the number of apparatuses to be operated via the input devices need to be provided. By utilizing the present invention, however, a plurality of apparatuses can be operated using a smaller number of input devices than the number of the apparatuses, e.g. using one input device.

(3) A program for enabling a CPU to execute a control process realizing each feature of the input device (see e.g. FIG. 5) may be distributed as being recorded on a recording medium or via various communication paths. Examples of such recording mediums include an IC card, an optical disc, a flexible disk, and a ROM. The program distributed can be stored for use in a memory readable by a CPU of an apparatus. The features of the input device described in the above embodiments are realized by the CPU executing the program.

(4) Although the above embodiments describe the case where the CPU is provided inside the input device, the CPU may be provided outside the input device.

(5) Although the second embodiment describes the case where the touch panel employed therein is a pressure-sensitive touch panel, it may instead be an electrostatic touch panel or an optical touch panel.

(6) Although the above embodiments describe the case where the operations of the input device are associated with its display-screen for displaying an input (see FIGS. 6 and 7), the operations of the input device may instead be associated with an audio output unit included therein. One example of such is an apparatus whose directions for use are given by audio and that is equipped with the input device of the present invention. In this case, a predetermined button of the input device may be blinked while directions regarding the button are being given.

(7) Although the above embodiments describe the case where a different image appears on each button, the same image may appear on a plurality of buttons. One example of such is the case where only two types of images “YES” and “NO” are to be displayed. The image “YES” may be displayed on each of a plurality of buttons in the upper half of the input device, and the image “NO” may be displayed on each of a plurality of buttons in the lower half of the input device. In this case, to enter “YES”, the user may press any one of the upper-half buttons on which “YES” is displayed, or the user may press any two or more of the upper-half buttons on which “YES” is displayed together. In this way, the operability of the input device can be improved.

(8) The above embodiments describe the case where neither the range of one button nor the shape of each button is changed. However, a plurality of buttons may be physically handled as one button, and also, the shape of each button may be physically changed. For these purposes, each button may be partially made from such a material that can flexibly change its shape by applying the current thereto, i.e., a material that can be swollen or shrunk depending on the applied current, specifically the direction and strength of the applied current, and can be hardened by stopping the current. In this case, a necessary part of each button can be made swollen by applying the current thereto. By utilizing such a material, a plurality of buttons can be deformed to have the same continuous height by filling gaps between adjacent buttons. Such a plurality of buttons with no gaps between adjacent buttons can then be handled as one button. Also, each button may be made from such a material that can memorize a certain shape, and become flexible by applying the current thereto so as to be deformed into the shape of a memorized pattern depending on the state of the applied current, specifically the direction and strength of the applied current. The shape of a button can then be changed by applying the current through the button. In this way, buttons of the input device can be user-friendly with easy and intuitive operations.

(9) Although the above embodiments describe the case where a solid black image is displayed on a button that does not cause any processing when pressed, no image may be displayed on such a button.

Alternatively, the surface of a button that does not cause any processing when pressed may be darkened by lowering illuminance of a display panel placed behind such a button.

Further, a button that does not cause any processing when pressed may be formed in such a manner that the button cannot be physically moved down even if the user tries to press the button.

(10) Although the first embodiment describes the case where the buttons are made from a transparent material, the buttons may be made from a semi-transparent material. Although the second embodiment describes the case where the buttons, the touch panel, and the elastic member are made from a transparent material, these components may also be made from a semi-transparent material.

(11) Although the above embodiments describe the case where an image appearing on each button is a still image of characters, symbols, and the like, the image may be a moving image of characters, symbols, and the like.

(12) The above embodiments describe the case where the user operation of pressing a button triggers a change in a function allocated to each button, or a change in an image appearing on each button. However, predetermined vibrations given to the input device may trigger partial invalidation of a function allocated to each button. Further, tilting the input device at a predetermined angle may trigger a change in an image appearing on each button.

(13) Although the above embodiments describe the case where an image appearing on each button may be an image of alphabetical characters, it may also be an image of other characters such as Japanese characters.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An input device comprising:
one or more buttons on each of which an image is appearing;
a button-pressing detecting unit operable to detect a button-pressing operation; and
a button-image changing unit operable to change an image appearing on at least one of the buttons when the button-pressing detecting unit detects the button-pressing operation.

2. The input device of claim 1, wherein the button-image changing unit changes an image appearing on a button that has been pressed via the button-pressing operation detected by the button-pressing detecting unit.

3. The input device of claim 1, wherein the button-image changing unit changes an image appearing on a button other than a button that has been pressed via the button-pressing operation detected by the button-pressing detecting unit.

4. The input device of claim 1, further comprising
one or more display panels that are placed behind the one or more buttons,
wherein each button is at least partially made from one of a transparent material and a semi-transparent material, and
the button-image changing unit changes an image displayed on the one or more display panels, to change the image appearing on the at least one of the buttons.

5. The input device of claim 4, further comprising
one or more display panels that are placed behind the one or more buttons,
wherein each button is at least partially made from one of a transparent material and a semi-transparent material, and
the button-image changing unit changes an image displayed on the one or more display panels, to change the image appearing on the at least one of the buttons.

6. The input device of claim 4, further comprising
a transparent touch panel that is placed on the one or more display panels so as to be positioned between the one or more display panels and the one or more buttons; and
an elastic member that is placed between the transparent touch panel and the one or more buttons to space the touch panel and the one or more buttons,
wherein the pressing-operation detecting unit detects the button-pressing operation by the touch panel detecting a pressure generated by deformation of the elastic member.

7. The input device of claim 4, wherein
the one or more display panels are placed, in one-to-one correspondence, behind the one or more buttons, and
the corresponding display panel and button are bonded together.

8. The input device of claim 4, wherein
the button-image changing unit includes:
a correspondence storing unit operable to store therein information about correspondence of each button, a processing program, and an image; and
a button-processing analyzing unit operable to
(a) execute a processing program corresponding to a button that has been pressed via the button-pressing operation,
(b) redefine the correspondence of each button, a processing program, and an image, and
(c) display, in accordance with the redefined correspondence, images on the one or more display panels in such a manner that an image corresponding to each button appears on the corresponding button.

9. The input device of claim 10, further comprising:
a change-information obtaining unit operable to obtain information to be used for changing the correspondence; and
a correspondence changing unit operable to change the correspondence using the information obtained by the change-information obtaining unit.

10. The input device of claim 1, wherein
the image appearing on each button includes an image of a character.

11. A computer program that enables an input device to execute an image switching process of switching images appearing on buttons of the input device, the image switching process comprising:
a button-pressing detecting step of detecting pressing of a button; and
a button-image changing step of changing an image that is appearing on a button.
